(19) United States
(12) Patent Application Publication
(10) Pub. No.: US 2006/0258808 A1
(43) Pub. Date: Nov. 16, 2006

(54) Single component, waterborne coating compositions, related multi-component composite coatings and methods

(76) Inventors: Charles M. Kania, Natrona Heights, PA (US); George Yakulis JR., Allison Park, PA (US); Roxalana L. Martin, Pittsburgh, PA (US)

Correspondence Address: PPG Industries, Inc.;Intellectual Property Department, One PPG Place, Pittsburgh, PA, 15272, US

(21) Appl. No.: 11/125,463

(22) Filed: May 10, 2005

(51) Int. Cl. C08F 8/00

(52) U.S. Cl. 525/192; 526/319

(57) ABSTRACT

Disclosed are single component storage stable, waterborne coating compositions. The coating compositions comprise a film-forming resin composition comprising a first film-forming resin comprising an acrylic polyol, a second film-forming resin, and a curing agent. Also disclosed are substrates at least partially coated with a coating deposited from such compositions, multi-component composite coatings wherein at least one coating layer is deposited from such compositions, and methods for improving the mar and/or chemical resistance of a coating deposited from a single component storage stable waterborne coating composition.

### FIELD OF THE INVENTION

The present invention relates to single component storage stable, waterborne coating compositions. The coating compositions comprise a film-forming resin composition comprising a first film-forming resin, a second film-forming resin, and a curing agent. The present invention is also directed to substrates at least partially coated with a coating deposited from such a composition, multi-component composite coatings wherein at least one coating layer is deposited from such a composition, and methods for improving the mar and/or chemical resistance of a coating deposited from a single component storage stable waterborne coating composition.

### BACKGROUND INFORMATION

Reducing the environmental impact of coating compositions, such as that associated with emissions into the air of volatile organics during their application has been an area of ongoing investigation and development in recent years. Accordingly, interest has increased in coating compositions containing low levels of volatile organic compounds (“low VOC coating compositions”). In the automotive original equipment manufacture (OEM) market, for example, low VOC coating compositions are desirable due to the relatively large volume of coatings that are used. However, in addition to the desire for low VOC coating compositions, automotive manufacturers have strict performance requirements for such coatings. For example, automotive OEM clear top coats are typically required to have a combination of good exterior durability, mar resistance, acid etch and water spot resistance, and excellent gloss and appearance.

As a result, to provide improved coatings for motor vehicles, the industry has sought solutions to the problem of damage due to the action of acid rain and road dirt, and debris that may strike areas of the vehicle. These strikes can result in unaesthetic marring of the clear coat. “Mar resistance” refers to the ability of a coating composition to maintain its appearance when the coating comes in contact with an abrasive material. “Chemical resistance” refers to the ability of a coating composition to resist attack from chemicals, such as the acids associated with acid rain.

Historically, the mar resistance of a coating has been improved through the addition of microparticulate materials such as silica, metal sulfides, and crosslinked styrene-butadiene. A drawback to the use of such materials, however, is that appearance properties, such as gloss and distinctness of image of the coating system, can, in some cases, be adversely affected due to light scattering at the particle surfaces.

Thus, it would be desirable to provide single component, waterborne coating compositions that can provide coatings exhibiting good mar and/or chemical resistance, while maintaining favorable appearance properties.

### SUMMARY OF THE INVENTION

In certain respects, the present invention is directed to single component storage stable, waterborne, coating compositions. These coating compositions comprise a film-forming resin composition comprising: (a) a first film-forming resin comprising an acrylic polyol which is the polymerization product of polymerizable materials comprising (i) a compound of the structure 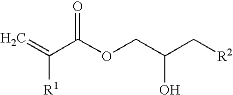
wherein R¹ is H or CH₃, and R² is 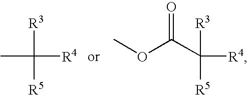
wherein R³ is H or an alkyl group, R⁴ is an group, and R⁵ is an alkyl group containing at least four carbon atoms, (ii) a hydroxy-containing ethylenically unsaturated polymerizable material different from (i), and (iii) an ethylenically unsaturated polymerizable material that is free of hydroxyl groups; (b) a second film forming resin comprising reactive functional groups, wherein the second film-forming resin is different from the first film-forming resin, and (c) a curing agent comprising functional groups reactive with the functional groups of the first film-forming resin and the second film-forming resin.

The present invention is also directed to substrates at least partially coated with a coating deposited from such a composition, methods for at least partially coating a substrate with such a composition, multi-component composite coatings wherein at least one coating layer is deposited from such a composition, and substrates at least partially coated with such a multi-component composite coating.

In other respects, the present invention is directed to methods for improving the mar and/or chemical resistance of a coating deposited from a single component storage stable, waterborne, coating composition. Such methods comprise including in the coating composition an acrylic polyol which is the polymerization product of polymerizable materials comprising (i) a compound of the structure 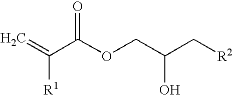
wherein R¹ is H or CH₃, and R² is 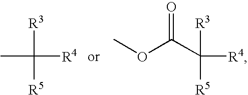
wherein R³ is H or an alkyl group, R⁴ is an alkyl group, and R⁵ is an alkyl group containing at least four carbon atoms, (ii) a hydroxy-containing ethylenically unsaturated polymerizable material, and (iii) an ethylenically unsaturated polymerizable material that is free of hydroxyl groups.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating compositions that, comprise “a curing agent”. Such references to “a curing agent” is meant to encompass coating compositions comprising one curing agent as well as coating compositions that comprise more than one curing agent, such as coating compositions that comprise two or three different curing agents. In addition, in this application, the use of “or” means “and/or” unless specifically stated otherwise, even though “and/or” may be explicitly used in certain instances.

As previously indicated, certain embodiments of the present invention are directed to “single component storage stable” coating compositions. As used herein, the term “single component storage stable” means that the coating composition can be formulated as a one-component composition where, during storage of the composition, the composition components, including the curing agent, are admixed together but the properties of the composition, including viscosity, remain consistent enough over the time of storage to permit successful application of the coating onto a substrate at a later time.

As previously indicated, certain embodiments of the present invention are directed to “waterborne” coating compositions. As used herein, the term “waterborne” means that the solvent or carrier fluid for the coating composition primarily or principally comprises water. For example, in certain embodiments, the carrier fluid is at least 80 weight percent water.

Certain embodiments of the present invention are directed to coating compositions that are “low VOC” coating compositions. As used herein, the term “low VOC composition” means that the composition contains no more than three (3) pounds of volatile organic compounds per gallon of the composition. In certain embodiments, the coating compositions of the present invention comprise no more than one (1) pound of volatile organic compound per gallon of the coating composition. As used herein, the term “volatile organic compound” refers to compounds that have at least one carbon atom and which are released from the composition during drying and/or curing thereof. Examples of “volatile organic compounds” include, but are not limited to, alcohols, benzenes, toluenes chloroforms, and cyclohexanes.

As previously indicated, certain embodiments of the coating compositions of the present invention comprise a film-forming resin composition. As used herein, the term “film-forming resin composition” is meant to include compositions that comprise polymers capable of forming a film (i.e., film-forming resins), curing agent(s), and catalysts or accelerators (if any) that may be included to facilitate the reaction between the film-forming resin(s) and the curing agent(s).

In certain embodiments, the film-forming resin composition included within the coating compositions of the present invention comprises a first film-forming resin comprising an acrylic polyol that is made by addition polymerization of different unsaturated polymerizable materials, at least one of which includes the structure 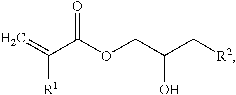
wherein R¹ is H or CH₃, and R² is 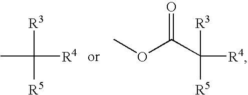
wherein R³ is H organ alkyl group, R⁴ is an alkyl group, and R⁵ is an alkyl group containing at least four carbon atoms (hereinafter referred to as “unsaturated polymerizable material A”). Mixtures of two or more different types of the foregoing materials may be used.

The unsaturated polymerizable material A comprises an acrylate or methacrylate in which the esterifying group is the residue of a glycidyl group which is, in turn, bound to a terminal group that includes a branched alkyl group, such as a tertiary alkyl group. In certain embodiments, at least one of the alkyl branches in the terminal group includes a chain four or more carbon atoms in length, or, in some cases, eight or more carbon atoms in length. Without being bound by any theory, it is believed that the substantial chain length of the unsaturated polymerizable material A, and its inclusion of alkyl groups of substantial length, permit the acrylic polyols into which it is polymerized to have very rapid drying rates without a substantial loss of hardness in the final coating that might otherwise be expected of such a structure.

In certain embodiments, the unsaturated polymerizable material A is synthesized by reacting acrylic or methacrylic acid with a monoepoxide having, substantial hydrocarbon chain length, such as commercially available epoxidized alpha olefins of the formula: 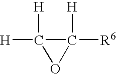
where R⁶ includes a branched alkyl group having at least 6 carbon atoms, such: as at least 8 carbon atoms. Polyepoxies such as certain of the commercially available family of EPON products may be used if partially defunctionalized to form monoepoxies. In certain embodiments, the terminal group in the esterifying group of the unsaturated polymerizable material A itself includes an ester group, in which case the monomer may be the reaction product of acrylic acid or methacrylic acid and CARDURA E, a glycidyl ester of Versatic acid sold by Resolution. Versatic acid is a synthetic blend of isomers of saturated tertiary alkyl monoacid having nine to eleven carbon atoms. The (meth)acrylic acid and CARDURA E reaction yields the following structure: 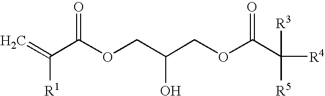
wherein R¹, R³, R⁴, and R⁵ are as defined above. In certain embodiments, the ethylenically unsaturated material A with an ester-containing terminal group may be produced from the reaction of glycidyl acrylate or glycidyl methacrylate with a long chain organic acid such as Versatic acid, neodecanoic acid, or isostearic acid.

As previously indicated, the first film-forming resin included within the film-forming resin composition of the coating compositions of the present invention is, in certain embodiments, also made from a hydroxy containing ethylenically unsaturated polymerizable material different from the unsaturated polymerizable material A (hereinafter referred to as “unsaturated polymerizable material B”). Examples of materials suitable for use as the unsaturated polymerizable material B are vinyl monomers, such as hydroxyalkyl acrylates and methacrylates, including the acrylic acid and methacrylic acid esters of ethylene glycol and propylene glycol. These acrylates and methacrylates often have 2 to 6 carbon atoms in the alkyl group. Also suitable are hydroxy-containing esters and/or amides of unsaturated acids such as maleic acid, fumaric acid, itaconic acid and the like.

In certain embodiments, the unsaturated polymerizable material B comprises a mixture of two or more of the foregoing materials. In certain embodiments, unsaturated polymerizable material B comprises a mixture of materials wherein at least one of the materials comprises a primary hydroxy group, such as hydroxyethyl (meth)acrylate and 1-butyl (meth)acrylate. As used herein, the term “(meth)acrylate” is meant to include both acrylates and methacrylates. In certain embodiments, such mixtures comprise at least 2 percent by weight of materials comprising a primary hydroxy group, based on the total weight of unsaturated polymerizable material B.

The first film-forming resin included within the film-forming resin composition of the coating compositions of the present invention is also made from an ethylenically unsaturated polymerizable material that is free of hydroxyl groups (hereinafter referred to as “unsaturated polymerizable material C”). Examples of materials suitable for use as the unsaturated polymerizable materials C are vinyl monomers, such as alkyl, cycloalkyl, or aryl acrylates and methacrylates having 2 to 6 carbon atoms in the esterifying group. Specific examples include methyl methacrylate and t-butyl methacrylate. Other suitable materials include lauryl methacrylate, 2-ethylhexyl methacrylate, isobornyl methacrylate, and cyclohexyl methacrylate. An aromatic vinyl monomer that is often included is styrene. Other materials that may be used as unsaturated polymerizable material C are ethylenically unsaturated materials such as monoolefinic and diolefinic hydrocarbons, unsaturated esters of organic and inorganic acids, amides and esters of unsaturated acids, nitriles, and unsaturated acids. Examples of such monomers include, without limitation, 1,3-butadiene, acrylamide, acrylonitrile, alpha-methyl styrene, alpha-methyl chlorostyrene, vinyl butyrate, vinyl acetate, allyl chloride, divinyl benzene, diallyl itaconate, triallyl cyanurate, as well as mixtures thereof.

In certain embodiments, the particular species chosen for the ethylenically unsaturated polymerizable material C includes a substantial quantity of one or more monomers that have the characteristic of raising the glass transition temperature (Tg) of the acrylic polyol. Monomers that may serve this purpose include, without limitation, substituted and unsubstituted isobornyl (meth)acrylate, trimethylcyclohexyl methacrylate, t-butyl methacrylate, and cyclohexyl methacrylate. As a result, in certain embodiments, isobornyl methacrylate is present in an amount of at least 20 percent by weight, based on the total weight of ethylenically unsaturated polymerizable materials that are used to make the acrylic polyol.

In certain embodiments, the first film-forming resin included within the film-forming resin composition of the coating compositions of the present invention is also made from an ethylenically unsaturated polymerizable material that comprises carboxylic acid groups (hereinafter referred to as “unsaturated polymerizable material D”). Virtually any unsaturated acid functional monomer may be used, for example, acrylic acid, methacrylic acid, itaconic acid, and half esters of unsaturated dicarboxylic acids such as maleic acid. When included, the amount of unsaturated polymerizable material D often constitutes from 0.1 to 5 percent by weight, such as 0.1 to 2 percent by weight, based on the resins solids of the total monomer combination used to prepare the acrylic polyol.

In certain embodiments, the first film-forming resin comprises an acrylic polyol having a hydroxyl number ranging from 40 to 110, such as from 60 to 95, or, in some cases, from 65 to 80 mg KOH/gram of polymer as determined by well known potentiometric techniques. In certain embodiments, such an acrylic polyol generally has a number average molecular weight ranging from 500 to 4000, such as from 1000 to 2500, the molecular weight determined by gel permeation chromatography (GPC) using polystyrene as standard.

In certain embodiments, the first film-forming resin described above may be synthesized from a combination of unsaturated polymerizable materials comprising (a) 0.5 to 15 percent by weight, such as 1 to 10 percent by weight, of unsaturated polymerizable material A; (b) up to 45 percent by weight, such as 5 to 40 percent by weight, or, in some cases, 10 to 35 percent by weight, of unsaturated polymerizable material B; and (c) 40 to 98 percent by weight, such as 50 to 80 percent by weight, of unsaturated polymerizable material C, wherein the percentages are based on total resin solids weight of the polymerizable material used to make the first film-forming resin.

Use of certain embodiments of the acrylic polyol described above in two-component, solventborne coating compositions is described in U.S. Pat. No. 6,130,286. Suitable processes and conditions for making the acrylic polyol described above are set forth in those patents and in the Examples herein. For example, polymerization of the unsaturated polymerizable materials can be carried out in bulk, in aqueous or organic solvent solution, such as xylene, methyl isobutyl ketone, and n-butyl acetate, in emulsion, or in aqueous dispersion. The polymerization can be effected by means of a suitable initiator system, which often includes free radical initiators, such as di-t-amyl peroxide or azobisisobutyronitrile. Molecular weight can be controlled by choice of solvent or polymerization medium, concentration of initiator or monomer, temperature, and the use of chain transfer agents. If additional information is needed, such polymerization methods are disclosed in Kirk-Othmer, Vol. 1, at pp. 203-05, 259-97; and 305-07, the cited portions of which being incorporated herein by reference.

In certain embodiments, an aqueous dispersion is formed comprising the first film-forming resin. As a result, certain embodiments of the present invention are directed to aqueous dispersions comprising the first film-forming resin described above. As used herein, the term “aqueous dispersion” refers to a system wherein an organic component is in the dispersed phase as particles distributed throughout the continuous phase, which includes water. As used herein, the term “organic component” is meant to encompass all of the organic species present in the aqueous dispersion, including the film-forming resin(s) and organic solvents, if any.

A suitable method for making such an aqueous dispersion is set forth in the Examples herein. In certain embodiments, the aqueous dispersion comprising the first film-forming resin is prepared by mixing the first film-forming resin and, if desired, other ingredients such as neutralizing agents, external surfactants, catalysts, flow additives and the like together with water under agitation to form a semi-stable oil-in-water pre-emulsion mixture. This pre-emulsion mixture is then subject to sufficient stress to effect information of polymeric microparticles. Residual organic solvents are then removed azeotropically under reduced pressure distillation at low temperature (i.e., less than 60° C.) to yield an aqueous dispersion of polymeric microparticles that may be substantially free of organic solvent.

In certain embodiments, the continuous phase of the aqueous dispersion comprises exclusively water. In some embodiments, however, organic solvent may be present in the aqueous dispersion as well to, for example, assist in lowering the viscosity of the polymer to be dispersed. For example, in certain embodiments, the aqueous dispersion comprises up to 20 weight percent, such as up to 5 weight percent, or, in some cases, up to 2 weight percent organic solvent, with weight percent being based on the total weight of the aqueous dispersion. Examples of suitable solvents which can be incorporated in the organic component of the aqueous dispersion are xylene, methyl isobutyl ketone, and n-butyl acetate.

In certain embodiments, the pre-emulsion mixture described above is subject to appropriate stress to achieve the requisite particle size of the polymeric microparticles. Suitable methods of forming such polymeric microparticles are disclosed in U.S. Pat. No. 6,462,139 at col. 10 lines 5-47, the cited portion of which being incorporated herein by reference.

In certain embodiments, the first film-forming resin is present in the aqueous dispersion in an amount of 5 to 50 percent by weight, such as 30 to 40 percent by weight, based on the total weight of resin solids in the aqueous dispersion.

In certain embodiments, the first film-forming resin is present in the coating composition in an amount of 15 to 40 percent by weight, such as 20 to 30 percent by weight, based on the total weight of resin solids in the composition.

In certain embodiments of the present invention, the film-forming resin composition comprises a second film-forming resin that is different from the first film-forming resin described earlier and which comprises reactive functional groups. The second film-forming resin may comprise any of a variety of reactive group-containing polymers well-known in the surface coatings art. Suitable non-limiting examples can include, without limitation, acrylic polymers, polyester polymers, polyurethane polymers, polyether polymers, polyepoxide polymers, copolymers thereof, and mixtures thereof. Also, the second film-forming resin may comprise a variety of reactive functional groups such as, for example, hydroxyl groups, amino groups, and/or isocyanate groups.

In certain embodiments, the second film-forming resin comprises a hydroxyl group-containing polymer, such as, for example, an acrylic polyol, a polyester polyol, a polyurethane polyol, a polyether polyol, or a mixture thereof. In certain embodiments, the second film-forming resin comprises an acrylic polyol different from the acrylic polyol described earlier and having an hydroxyl equivalent weight ranging from 1000 to 100 grams per solid equivalent, or, in certain embodiments, 500 to 150 grams per solid equivalent.

As indicated, in certain embodiments, the second film-forming resin comprises an acrylic polymer that is different from the previously-described acrylic polyol. In such embodiments, suitable hydroxyl group containing acrylic polymers can be prepared from polymerizable ethylenically unsaturated monomers and are often copolymers of (meth)acrylic acid and/or hydroxyalkyl esters of (meth)acrylic acid with one or more other polymerizable ethylenically unsaturated monomers, such as alkyl esters of (meth)acrylic acid, including methyl (meth)acrylate, ethyl (meth)acrylate, butyl (meth)acrylate and 2-ethyl hexylacrylate, and vinyl aromatic compounds, such as styrene, alpha-methyl styrene, and vinyl toluene. As used herein, “(meth)acrylic” and terms derived therefrom are intended to include both acrylic and methacrylic.

In the embodiments of the present invention wherein the second film-forming resin is an acrylic polymer, the polymer may, for example, be prepared from ethylenically unsaturated, beta-hydroxy ester functional materials. Such materials may, for example, be derived from the reaction of an ethylenically unsaturated acid functional monomer, such as a monocarboxylic acid, e.g., acrylic acid, and an epoxy compound which does not participate in the free radical initiated polymerization with such unsaturated acid functional monomer. Non-limiting examples of such epoxy compounds include glycidyl ethers and esters. Suitable glycidyl ethers include, for example, glycidyl ethers of alcohols and phenols, such as butyl glycidyl ether, octyl glycidyl ether, phenyl-glycidyl ether, and the like. Suitable glycidyl esters include, for example, those commercially available from Resolution under the tradename CARDURA E. Alternatively, the beta-hydroxy ester functional monomers can be prepared from an ethylenically unsaturated, epoxy functional monomer, such as, for example, glycidyl (meth)acrylate and allyl glycidyl ether, and a saturated carboxylic acid, such as, for example, a saturated monocarboxylic acid, such as, for example, isostearic acid.

Such acrylic polymers prepared from polymerizable ethylenically unsaturated monomers may, for example, be prepared by solution polymerization techniques, such as was described above with respect to the first film-forming resin. The Examples set forth herein also identify a suitable method of preparing such a polymer.

As mentioned earlier, the second film-forming resin may also comprise a polyester polymer. In these embodiments, useful polyester polymers often include the condensation products of polyhydric-alcohols and polycarboxylic acids. Suitable polyhydric alcohols can include, for example, ethylene glycol, neopentyl glycol, trimethylol propane, and pentaerythritol. Suitable polycarboxylic acids can include, for example, adipic acid, 1,4-cyclohexyl dicarboxylic acid, and hexahydrophthalic acid. Besides the polycarboxylic acids mentioned above, functional equivalents of the acids such as anhydrides where they exist or lower alkyl esters of the acids such as the methyl esters can be used. Also, small amounts of monocarboxylic acids such as stearic acid can be used. The ratio of reactants and reaction conditions are selected to result in a polyester polymer with the desired pendent functionality, such as hydroxyl functionality.

For example, hydroxyl group-containing polyesters can be prepared by reacting an anhydride of a dicarboxylic acid such as hexahydrophthalic anhydride with a diol such as neopentyl glycol in a 1:2 molar ratio. Where it is desired to enhance air-drying, suitable drying oil fatty acids may be used and include those derived from linseed oil, soya bean oil, tall oil, dehydrated castor oil, or tung oil.

In certain embodiments, the second film-forming resin may also comprise a polyurethane polymer containing terminal hydroxyl groups. In these embodiments, the polyurethane polyols that can be used include, for example, those prepared by reacting polyols including polymeric polyols with polyisocyanates. Examples of suitable polyisocyanates include, for example, those described in U.S. Pat. No. 4,046,729 at column 5, line 26 to column 6, line 28, incorporated herein by reference. Examples of suitable polyols include, for example, those described in U.S. Pat. No. 4,046,729 at column 7, line 52 to column 10, line 35, incorporated herein by reference.

In certain embodiments, the second film-forming resin may also comprise a polyether polymer containing terminal hydroxyl groups. Examples of suitable polyether polyols include polyalkylene ether polyols such as those having the following structural formula: 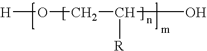
wherein the substituent R is hydrogen or a lower alkyl group containing from 1 to 5 carbon atoms, including mixed substituents, and n has a value typically ranging from 2 to 6 and m has a value ranging from 8 to 100 or higher. Exemplary polyalkylene ether polyols include, for example, poly(oxytetramethylene) glycols, poly(xytetraethylene) glycols, poly(oxy-1,2-propylene) glycols and poly(oxy-1,2-butylene) glycols.

Also useful are polyether polyols formed from oxyalkylation of various polyols, for example, glycols such as ethylene glycol, 1,6-hexanediol, Bisphenol A, and the like, or other higher polyols such as trimethylolpropane, pentaerythritol, and the like. Polyols of higher functionality can be made; for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Specific examples of polyethers include those sold under the names TERATHANE and TERACOL, available from E. I. Du Pont de Nemours and Company, Inc.

In certain embodiments, the second film-forming resin comprises a polymer having a weight average molecular weight (Mw) typically ranging from 1000 to 20,000, such as from 1500 to 15,000, or, in some cases, from 2000 to 12,000 as determined by gel permeation chromatography using a polystyrene standard.

In certain embodiments, an aqueous dispersion is formed comprising the second film-forming resin. In certain embodiments, the second film-forming resin is included in the aqueous dispersion comprising the first film-forming resin described earlier. In other embodiments, an aqueous dispersion is formed comprising the second film-forming resin but not the first film-forming resin. In yet other embodiments, the second film-forming resin is both included in the aqueous dispersion comprising the first film-forming resin and it is included in an aqueous dispersion that does not include the first film-forming resin.

Suitable methods for making an aqueous dispersion comprising the second film-forming resin are set forth in the Examples and include the method described earlier with respect to the aqueous dispersion comprising the first film-forming resin.

In certain embodiments, the second film-forming resin is present in the coating composition in an amount of 15 to 40 percent by weight, such as 20 to 30 percent by weight, based on the total weight of resin solids in the composition.

As previously indicated, certain embodiments of the present invention comprise a film-forming resin composition comprising a curing agent comprising functional groups reactive with the functional groups of the first film-forming resin and the second film-forming resin. Non-limiting examples of suitable curing agents include, for example, aminoplasts and blocked polyisocyanates, including mixtures thereof, such as curing agent(s) that are adapted to be water soluble or water dispersible, provided that the coating composition is a single component storage stable coating composition, as previously described.

Examples of suitable aminoplast resins include those containing methylol or similar alkylol groups, a portion of which have been etherified by reaction with a lower alcohol, such as methanol, to provide a water soluble/dispersible aminoplast resin. Appropriate aminoplast resin include those commercially available from Cytec Industries, Inc. under the tradenames CYMEL 303 and CYMEL 327. An example of a suitable blocked isocyanate which is water soluble/dispersible is dimethylpyrazole blocked hexamethylene diisocyanate trimer commercially available as BI, 7986 from Baxenden Chemicals, Ltd. in Lancashire, England.

In certain embodiments, the curing agent comprises a mixture of materials comprising an aminoplast resin and a blocked isocyanate comprising dimethylpyrazole blocked hexamethylene diisocyanate trimer. In certain embodiments, the aminoplast resin and the dimethylpyrazole blocked hexamethylene diisocyanate trimer are present in such a mixture at a weight ratio of 1:10 to 10:1, such as 1:2 to 1:6.

In certain embodiments, the curing agent is present in the coating composition in an amount of 15 to 40 percent by weight, such as 20 to 30 percent by weight, based on the total weight of resin solids in the composition.

The coating compositions of the present invention can contain, in addition to the components described above, a variety of other adjuvant materials. If desired, other resinous materials can be utilized in conjunction with the aforementioned film-forming resins so long as the resultant coating composition is not detrimentally affected in terms of application, physical performance and appearance properties. Certain embodiments of the coating compositions of the present invention include surface active agents, such as any of the well known anionic, cationic or nonionic surfactants or dispersing agents.

The coating compositions of the present invention can further include inorganic and/or inorganic-organic particles, for example, silica, alumina, including treated alumina (e.g. silica-treated alumina known as alpha aluminum oxide), silicon carbide, diamond dust, cubic boron nitride, and boron carbide.

In certain embodiments, the present invention is directed to coating compositions as previously described wherein the composition comprises a plurality of inorganic particles. Such inorganic particles may, for example, be substantially colorless, such as silica, for example, colloidal silica. Other suitable inorganic microparticles include fused silica, amorphous silica, alumina, colloidal alumina, titanium dioxide, zirconia, colloidal zirconia and mixtures thereof. Such particles can have an average particle size ranging from sub-micron size (e.g. nanosized particles) up to 10 microns depending upon the end use application of the composition and the desired effect.

In certain embodiments, the particles comprise inorganic particles that have an average particle size ranging from 1 to 10 microns, or from 1 to 5 microns prior to incorporation into the coating composition. In other embodiments, the inorganic particles comprise aluminum oxide having an average particle size ranging from 1 to 5 microns prior to incorporation into the film-forming composition.

In certain embodiments, such inorganic particles can have an average particle size ranging from 1 to less than 1000 nanometers, such as from 1 to 100 nanometers, or, in some cases, from 5 to 50 nanometers, or, in yet other cases, 5 to 25 nanometers, prior to incorporation into the composition. These materials may constitute, in certain embodiments of the present invention, up to 30 percent by weight, such as 0.05 to 5 percent by weight, or, in some cases, 0.1 to 1 percent by weight, or, in yet other cases, 0.1 to 0.5 percent by weight, based on the total weight of the coating composition.

The coating compositions also may contain a catalyst to accelerate the cure reaction, for example, between the curing agent(s) and the reactive groups of the film-forming resin(s). Examples of suitable catalysts include organotin compounds such as dibutyl tin dilaurate, dibutyl tin oxide and dibutyl tin diacetate. Catalysts suitable for promoting the cure reaction between an aminoplast curing agent and the reactive hydroxyl of a film-forming resin(s) include acidic materials, for example, acid phosphates such as phenyl acid phosphate, and substituted or unsubstituted sulfonic acids such as dodecylbenzene sulfonic acid or paratoluene sulfonic acid. When used, the catalyst often is present in an amount ranging from 0.1 to 5.0 percent by weight, or, in some cases, 0.5 to 1.5 percent by weight, based on the total weight of resin solids present in the coating composition.

Other additive ingredients, for example, plasticizers, surfactants, thixotropic agents, anti-gassing agents, flow controllers, anti-oxidants, UV light absorbers and similar additives conventional in the art can be included in the compositions of the present invention. When used, these ingredients are often present in an amount of up to about 40 percent by weight based on the total weight of resin solids.

In certain embodiments, the coating compositions of the present invention may also comprise one or more other property enhancing additives, such as materials that may improve the sag and/or crater resistance of such a coating composition. Examples of such materials include (1) the reaction product of (a) a reactant comprising at least one isocyanate functional group with (b) an active hydrogen containing alkoxypolyalkylene compound, and/or (2) a reactive functional group-containing polysiloxane. Examples of such materials, which are suitable for use in the coating compositions of the present invention, are disclosed in copending U.S. patent application Ser. No. 10/841,662 at [0016] to [0026], the cited portion of which being incorporated by reference herein.

The coating compositions of the present invention also may, in certain embodiments, be formulated to include one or more pigments or fillers to provide color and/or optical effects, or opacity. Such pigmented coating compositions may be suitable for use in multi-component composite coatings as discussed below, for example, as a primer coating or as a pigmented base coating composition in a color-plus-clear system, or as a monocoat topcoat.

The solids content of the coating compositions of the present invention often ranges from 20 to 75 percent by weight, or 30 to 65 percent by weight, or 40 to 55 percent by weight, based on the total weight of the coating composition.

Suitable methods for making the coating compositions of the present invention are set forth in the Examples.

As aforementioned, the present invention is also directed to multi-component composite coatings. The multi-component composite coating compositions of the present invention comprise a base-coat coating composition-serving as a basecoat (often a pigmented color coat) and a coating composition applied over the basecoat serving as a topcoat (often a transparent or clear coat). At least one of the basecoat coating composition and the topcoat coating composition comprises a coating composition of the present invention. In certain embodiments, the clearcoat is deposited from a coating composition of the present invention and the basecoat coating composition comprises a resinous binder and, often, one or more pigments to act as the colorant. Particularly useful resinous binders for the basecoat coating composition are acrylic polymers, polyesters, including alkyds and polyurethanes.

The resinous binders for the basecoat coating composition can be organic solvent-based materials such as those described in U.S. Pat. No. 4,220,679, at col. 2 line 24 to col. 4, line 40, the cited portion of which being incorporated herein by reference. Also, water-based coating compositions such as those described in U.S. Pat. No. 4,403,003, U.S. Pat. No. 4,147,679 and U.S. Pat. No. 5,071,904 (incorporated herein by reference) can be used as the binder in the basecoat composition.

Suitable pigments for inclusion in such basecoat compositions include metallic pigments, such as aluminum flake, copper or bronze flake and metal oxide coated mica. In addition, the basecoat compositions can contain non-metallic color pigments conventionally used in surface coatings including inorganic pigments such as titanium dioxide, iron oxide, chromium oxide, lead chromate, and carbon black; and organic pigments such as, for example, phthalocyanine blue and phthalocyanine green.

Optional ingredients in the basecoat composition include those which are well known in the art of formulating surface coatings, such as surfactants, flow control agents, thixotropic agents, fillers, anti-gassing agents, organic co-solvents, catalysts, and other customary auxiliaries. Examples of these materials and suitable amounts are described in U.S. Pat. Nos. 4,220,679, 4,403,003, 4,147,679 and 5,071,904, which are incorporated herein by reference.

The basecoat compositions can be applied to the substrate by any conventional coating technique such as brushing, spraying, dipping or flowing, but they are most often applied by spraying. The usual spray techniques and equipment for air spraying, airless spray and electrostatic spraying in either manual or automatic methods can be used.

During application of the basecoat to the substrate, the film thickness of the basecoat formed on the substrate often ranges from 0.1 to 5 mils (2.54 to about 127 micrometers), or 0.1 to 2 mils (about 2.54 to about 50.8 micrometers).

After forming a film of the basecoat on the substrate, the basecoat can be cured or alternately given a drying step in which solvent is driven out of the basecoat film by heating or an air drying period before application of the clear coat. Suitable drying conditions will depend on the particular basecoat composition, and on the ambient humidity if the composition is water-borne, but often, a drying time of from 1 to 15 minutes at a temperature of 75° to 200° F. (21° to 93° C.) will be adequate.

The solids content of the base coating composition often generally ranges from 15 to 60 weight percent, or 20 to 50 weight percent.

The topcoat, which, as indicated earlier, often comprises a coating composition of the present invention, is often applied to the basecoat by spray application, however, the topcoat can be applied by any conventional coating technique as described above. Any of the known spraying techniques can be used such as compressed air spraying, electrostatic spraying and either manual or automatic methods. As mentioned above, the topcoat can be applied to a cured or to a dried basecoat before the basecoat has been cured. In the latter instance, the two coatings are then heated to cure both coating layers simultaneously. Curing conditions can range from 265° to 350° F. (129° to 175° C.) for 20 to 30 minutes. The topcoat thickness (dry film thickness) typically is 1 to 6 mils (about 25.4 to about 152.4 micrometers).

During application of the topcoat to the base coated substrate, ambient relative humidity generally can range from about 30 to about 80 percent, preferably about 50 percent to 70 percent.

In certain embodiments, after the basecoat is applied (and cured, if desired), multiple layers of clear topcoats can be applied over the basecoat. This is generally referred to as a “clear-on-clear” application. For example, one or more layers of a conventional transparent coat can be applied over the basecoat and one or more layers of transparent coating of the present invention applied thereon. Alternatively, one or more layers of a transparent coating of the present invention can be applied over the basecoat as an intermediate topcoat, and one or more conventional transparent coatings applied thereover.

The coating compositions of the present invention can be applied over virtually any substrate including wood, metals, glass, cloth, plastic, foam, including elastomeric substrates and the like. They are particularly useful in applications over metals and elastomeric substrates that are utilized in the manufacture of motor vehicles. As a result, the present invention is, also directed to substrates at least partially coated with a coating composition of the present invention.

As previously indicated, certain embodiments of the coating compositions of the present invention can provide coatings that exhibit favorable “mar” and/or “chemical” resistance. The mar resistance and chemical resistance of a coating can be evaluated as described in the Examples herein. Therefore, as should be apparent from the foregoing description, the present invention is also directed to methods for improving the mar and/or chemical resistance of a coating deposited from a single component storage stable waterborne coating composition. Such methods comprise including in the coating composition a film-forming resin that comprises an acrylic polyol which is the polymerization product of a combination of polymerizable materials comprising (i) a compound of the structure: 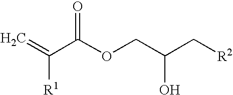
wherein R¹ is H or CH₃, and R² is 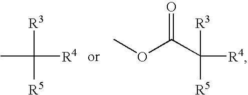
wherein R³ is H or an alkyl group, R⁴ is an alkyl group, and R⁵ is an alkyl group containing at least four carbon atoms, (ii) a hydroxy-containing ethylenically unsaturated polymerizable material, and (iii) an ethylenically unsaturated polymerizable material that is free of hydroxyl groups.

Illustrating the invention are the following examples, which, however, are not to be considered as limiting the invention to their details. Unless otherwise indicated, all parts and percentages in the following examples, as well as throughout the specification, are by weight.

### EXAMPLES

### Example #1

### Preparation of First Acrylic Polyol

An acrylic polyol was prepared as described below from the ingredients of Table 1. The amounts listed are total parts by weight in grams.

TABLE 1

| Ingredient | Amount |
|---|---|
| Charge 1 | |
| Cardura E 10P¹ | 618.53 |
| Methyl Isobutyl Ketone | 1024.98 |
| Charge #2 | |
| Styrene | 616.44 |
| 2-Ethyl Hexyl Acrylate | 219.14 |
| Hydroxy Ethyl Methacrylate | 429.63 |
| Acrylic Acid | 286.26 |
| Charge #3 | |
| Di-t-Amyl Peroxide² | 43.58 |
| Methyl Isobutyl Ketone | 183.66 |

¹Cardura E 10P is available from Resolution Performance Products.
²Di-t-Amyl Peroxide is available from Arkema as Luperox DTA.

Charge one was added to a vessel capable of being pressurized. The vessel and charge #1 were evacuated with nitrogen and heated to 124° C. The reactor was then pressurized and heating continued until a reaction temperature of 160° C. was achieved. At reaction temperature Charge #2 was added over a three hour period while Charge #3 was added over a 3½ hour period. Reaction temperature was maintained at 160° C. while the vessel had a pressure of 21-30 psi. When Charges 2 & 3 were complete, the reaction was held for one hour at 160° C. After this period the pressure was relieved and product cooled and discharged.

### Example #2

### Preparation of Second Acrylic Polyol

An acrylic polyol was prepared as described below from the ingredients of Table 2. The amounts listed are total parts by weight in grams.

TABLE 2

| Ingredient | Amount |
|---|---|
| Charge 1 | |
| Methyl Isoamyl Ketone | 603.2 |
| Charge #2 | |
| Hydroxy Propyl Acrylate | 110.6 |
| Hydroxy Ethyl Acrylate | 442.6 |
| Isobornyl Methacrylate | 576.3 |
| Butyl Methacrylate | 115.3 |
| Styrene | 530.2 |
| CARDURA E/Acrylic Acid Monomer³ | 115.3 |
| 4-Hydroxy Butyl Acrylate | 391.9 |
| Acrylic Acid | 23.1 |
| Charge #3 | |
| Di-t-Amyl Peroxide | 92.2 |
| Methyl Isoamyl Ketone | 227.4 |
| Charge #4 | |
| Methyl Isoamyl Ketone | 25 |
| Charge #5 | |
| Di-t-Amyl Peroxide | 23.1 |
| Methyl Isoamyl Ketone | 23.1 |
| Charge #6 | |
| Methyl Isoamyl Ketone | 13 |
| Charge #7 | |
| Methyl Isoamyl Ketone | 273.8 |

³Available from Resolution Performance Products.

Charge one was added to a vessel capable of being pressurized. The vessel and charge #1 were evacuated with nitrogen and heated to 115° C. The reactor was then pressurized and heating continued until a reaction temperature of 155° C. was achieved. At reaction temperature Charge #2 and Charge #3 were added over a three hour period. Reaction temperature was maintained at 155° C. while the vessel had a pressure of 24-30 psi. When Charges 2 & 3 were complete, Charge 4 was used to flush the feed lines. Charge #5 was then added over a one hour period followed by rinsing the feed line with Charge #6 and a one hour hold period. After this period the pressure was relieved and product cooled to less than 120° C., thinned with Charge #7 and discharged.

### Example #3

### Preparation of Aqueous Dispersion of Polymeric Microparticles

An aqueous dispersion of polymeric microparticles was prepared as described below from the ingredients of Table 3. The amounts listed are total parts by weight in grams.

TABLE 3

| Ingredient | Amount |
|---|---|
| Change #1 | |
| Acrylic Polyol of Example 1 | 1215.7 |
| Dimethyl Pyrazole Blocked | 660.6 |
| Hexamethylene Diisocyanate Trimer⁴ | |
| Acrylic Polyol of Example 2 | 1170.2 |
| Methyl Isobutyl Ketone | 53.7 |
| Dibutyl Tin Di-Laurate | 14.9 |
| Dimethyl Ethanol Amine | 28.8 |
| Charge #2 | |
| Deionized Water | 3580.6 |
| Dimethyl Ethanol Amine | 5.6 |
| Charge #3 | |
| Methyl Isobutyl Ketone | 53.7 |
| Charge #4 | |
| Deionized Water | 100.0 |
| Charge #5 | |
| Foam Kill 649⁵ | 1.0 |

⁴Available as BI 7986 from Baxenden Chemicals, Ltd., Lancashire, England.
⁵Available from Crucible Chemical.

Charge #1 was added to a 5 liter flask in order and placed under agitation until homogeneous. Charge #² was added to a 12 liter flask and agitated at 350 rpm's while holding temperature at 25° C. Charge #1 was added to Charge #2 over 1 hour. The flask used for Charge #1 was rinsed with Charge #3 and added to the mixture of Charge #1 and Charge #2. This mixture was held under agitation for 30 minutes. To disperse, the mixture was microfluidized at 11,500 psi, and Charge #4 was used as a rinse for the microfluidizer. Charge #5 was added to the dispersion. Vacuum was applied to 60 mm/Hg and the dispersion was heated to 50 to 60° C. Distillate was removed until 110° C. solids was equal to 50% and MIBK amount was less than 0.2% by weight in the dispersion. The dispersion was then cooled to <40° C., vacuum discontinued and the dispersion filtered. The resulting aqueous dispersion had a viscosity of 35 cps (Brookfield, #2 spindle, 60 rpm) and a pH of 8.07.

### Example #4

### Preparation of Aqueous Dispersion of Polymeric Microparticles

An aqueous dispersion of polymeric microparticles was prepared as described below from the ingredients of Table 4. The amounts listed are total parts by weight in grams.

TABLE 4

| Ingredient | Amount |
|---|---|
| Charge #1 | |
| Acrylic Polyol of Example 1 | 1495.3 |
| Methyl Isobutyl Ketone | 25.8 |
| Dimethyl Ethanol Amine | 28.4 |
| Charge #2 | |
| Deionized Water | 1718.7 |
| Dimethyl Ethanol Amine | 7.1 |
| Charge #3 | |
| Methyl Isobutyl Ketone | 25.8 |
| Charge #4 | |
| Deionized Water | 48.0 |
| Charge #5 | |
| Foam Kill 649 | 0.5 |

Charge #1 was added to a 2 liter flask in order and placed under agitation until homogeneous. Charge #2 was added to a 5 liter flask and agitated at 350 rpm's while holding temperature at 25° C. Charge #1 was added to Charge #2 over 1 hour. The flask used for Charge #1 was rinsed with Charge #3 and add to the mixture of Charge #1 and Charge #2. This mixture was held under agitation for 30 minutes. The mixture was then microfluidized at 11,500 psi, using Charge #4 as the rinse for the microfluidizer. Charge #5 was then added to the dispersion. Vacuum was applied to 60 mm/Hg and the dispersion was heated to 50 to 60° C. Distillate was removed until 110° C. solids was equal to 50% and MIBK amount was less than 0.2% by weight in the dispersion. The dispersion was then cooled to <40° C., vacuum discontinued and the dispersion filtered. The resulting aqueous dispersion had a viscosity of 192 cps (Brookfield, #2 spindle, 60 rpm) and a pH of 7.7.

### Example #5

### Preparation of Single Component, Waterborne Coating Composition

A single component, waterborne coating composition was prepared as described below from the ingredients of Table 5. The amounts listed are total parts by weight in grams.

TABLE 5

| Ingredient | Amount |
|---|---|
| Dispersion of Example 3 | 72.8 |
| Dispersion of Example 4 | 156.7 |
| Premix #1 | |
| Tinuvin 1130⁶ | 1.87 |
| Tinuvin 292⁷ | 1.2 |
| Byk 325⁸ | 0.28 |
| Byk 335⁹ | 0.42 |
| Byk 345¹⁰ | 1.24 |
| Isosteryl Alcohol¹¹ | 4.9 |
| Cymel 303¹² | 20.0 |
| Cymel 327¹³ | 10.0 |
| Siloxane Polyol¹⁴ | 1.94 |
| Premix #2 | |
| Dodecylbenzylsulfonic Acid¹⁵ | 0.2 |
| Dimethylethanolamine (50% in | 0.182 |
| deionized water)¹⁶ | |
| Deionized Water | 0.160 |

⁶Tinuvin ® 1130 available from Ciba Additives.
⁷Tinuvin ® 292 available from Ciba Additives.
⁸Byk ® 325 Methylalkyl Polysiloxane Copolymer available from Byk Chemie.
⁹Byk ® 355 Polyacrylate Solution available from Byk Chemie.
¹⁰Byk ® 345 Polyether modified Polydimethyl Siloxane available from Byk Chemie.
¹¹Isosteryl Alcohol available from Goldschmidt.
¹²Cymel ® 303 available from Cytec.
¹³Cymel ® 327 available from Cytec.
¹⁴AL-42-7015T commercially available from PPG Industries, Inc.
¹⁵Dodecylbenzylsulfonic Acid available from Cyanamid.
¹⁶Dimethylethanolamine available from PPG Industries Inc.

Premix 2 was prepared by mixing the components thereof. Premix 1 was prepared by mixing Premix 2 with the Tinuvin 1130, Tinuvin 292, Byk 325, Byk 355, Byk 345, Isosteryl Alcohol, Cymel 303, and Cymel 327, and blending for 5 minutes. The siloxane was then added and the mixture blended for an additional 5 minutes. The dispersions of Examples 3 and 4 were then added under agitation to premix #1. The mixture was blended for 30 minutes before adjusting to spray viscosity (28-32″ #4 DIN Cup) with the deionized water.

### Test Substrates

The test substrates were ACT cold roll steel panels (4″×12″) supplied by ACT Laboratories, Inc. and were electrocoated with a cationic electrodepositable primer commercially available from PPG Industries, Inc. as ED-6060. The panels were then spray coated with one coat of BASF Base 1, to a film thickness of from 0.4 to 0.6 mils, flashed 5 minutes at ambient conditions, dehydrated for 5 minutes at 176° F. (80° C.), and cooled to ambient temperature. The panels were then spray coated with two coats of BASE Base 2, to a film thickness of from 0.4 to 0.6 mils, flashed 5 minutes at ambient conditions, and dehydrated for 7 minutes at 176° F. (80° C.), and then cooled to ambient temperature. After cooling, the composition of Example 5 was spray applied, with a target film thickness of 1.3 to 1.7 mils, in two coats without flash time between coats. The substrates were then flashed for 2 minutes at ambient temperature and then the coated substrates were placed in an oven at 150° C., prior to increasing the oven temperature to 311° C. The coated substrates were cured for 23 minutes in an oven set at 311° C. Appearance and properties for the coatings are reported in Table 6.

TABLE 6

| Initial | | | Mar | |
|---|---|---|---|---|
| Gloss¹⁷ | Haze¹⁷ | DOI¹⁸ | Resistance¹⁹ | Acid Spot Test #1²⁰ |
| 94 | 167 | 78 | 52 | 48 |
| ¹⁷Gloss and Haze of test panels was determined at a 20° angle using a Haze, Gloss Reflectometer commercially available from BYK Gardner, Inc. | | | | |
| ¹⁸Distinctness of image (“DOI”) of sample panels was determined using a Dorigon II DOI Meter, which is commercially available from Hunter Lab, where a higher value indicates better coating appearance on the test panel. | | | | |
| ¹⁹Coated panels were subjected to scratch testing by linearly scratching the coated surface with a weighted abrasive paper for ten double rubs using an Atlas AATCC Scratch Tester, Model CM-5, available from Atlas Electrical Devices Company of Chicago, Illinois. The abrasive paper used was 3M 281Q WETORDRY ™ PRODUCTION ™ 9 micron polishing paper sheets, which are commercially available from 3M Company of St. Paul, Minnesota. Panels were then | | | | |
| # rinsed with tap water and carefully patted dry with a paper towel. The 20° gloss was measured (using the same gloss meter as that used for the initial 20° gloss) on the scratched area of each test panel. Using the lowest 20° gloss reading from the scratched area, the mar resistance results are reported as the percent of the initial gloss lost after scratch testing using the following calculation: 100% * (scratched gloss/initial gloss). Higher values | | | | |
| # for percent of gloss retained are desirable: | | | | |

²⁰A solution of 1% sulfuric acid in deionized water was prepared. The solution was applied to the surface of the test panels in the form of 32 spots of 50 microliter droplets using a 50 microliter octapette. The panels were then baked at 120° F. for 30 minutes. Then the panels were removed from the oven washed with soap and water and then dried. After allowing the panels to set for 1 hour, the temperature at which damage occurred was recorded.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the embodiments described in detail herein are illustrative only and are not limiting to the scope of the invention which is to be given the full breadth of the appended claims and any and all equivalents thereof.

We claim:

1. A single component, waterborne, storage stable coating composition comprising a film-forming resin composition comprising:
(a) a first film-forming resin comprising an acrylic polyol which is the polymerization product of polymerizable materials comprising:
(i) a compound of the structure 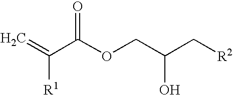
wherein R¹ is H or CH₃, and R² is 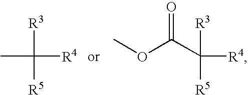
wherein R³ is H or an alkyl group, R⁴ is an alkyl group, and R⁵ is an alkyl group containing at least four carbon atoms,
(ii) a hydroxy-containing ethylenically unsaturated polymerizable material different from (i), and
(iii) an ethylenically unsaturated polymerizable material that is free of hydroxyl groups; and
(b) a second film-forming resin that comprises reactive functional groups and which is different from the first film-forming resin; and
(c) a curing agent comprising functional groups reactive with the functional groups of the first film-forming resin and the second film-forming resin.

2. The coating composition of claim 1, wherein the composition comprises a low VOC coating composition.

3. The coating composition of claim 1, wherein the compound of the structure 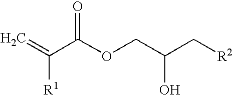
has the structure

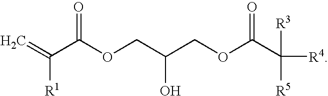

4. The coating composition of claim 1, wherein the hydroxy-containing ethylenically unsaturated polymerizable material different froth (i) comprises a mixture of materials wherein at least one of the materials comprises a primary hydroxy group.

5. The coating composition of claim 4, wherein the mixture comprises at least 2 percent by weight of a material comprising a primary hydroxy group, based on the total weight of the hydroxy-containing ethylenically unsaturated polymerizable material different from (i).

6. The coating composition of claim 1, wherein the ethylenically unsaturated polymerizable material that is free of hydroxyl groups comprises isobornyl methacrylate.

7. The coating composition of claim 6, wherein the isobornyl methacrylate is present in an amount of at least 20 percent by weight, based on the total weight of the ethylenically unsaturated polymerizable materials that are used to make the acrylic polyol.

8. The coating composition of claim 1, wherein the first film-forming resin comprises an acrylic polyol which is the polymerization product of polymerizable materials further comprising:
(iv) an ethylenically unsaturated polymerizable material comprising carboxylic acid groups.

9. The coating composition of claim 8, wherein the ethylenically unsaturated polymerizable material comprising carboxylic acid groups constitutes from 0.1 to 2 percent by weight, based on the resin solids of the monomer combination used to prepare the acrylic polyol.

10. The coating composition of claim 1, wherein the acrylic polyol is the polymerization product of polymerizable materials comprising:
(i) 1 to 10 percent by weight, based on the total weight of polymerizable materials, of a compound of the structure 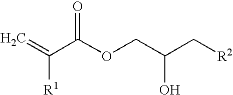
wherein R¹ is H or CH₃, and R² is 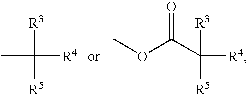
wherein R³ is H or an alkyl group, R⁴ is an alkyl group, and R⁵ is an alkyl group containing at least four carbon atoms,
(ii) 5 to 40 percent by weight, based on the total weight of polymerizable materials, of a hydroxy-containing ethylenically unsaturated polymerizable material different from (i), and
(iii) 5 to 80 percent by weight, based on the total weight of polymerizable materials, of an ethylenically unsaturated polymerizable material that is free of hydroxyl groups.

11. The coating composition of claim 1, wherein the second film-forming resin comprises an acrylic polyol.

12. The coating composition of claim 1, wherein the first film-forming resin is present in the coating composition in an amount of 20 to 30 percent by weight, based on the total weight of resin solids in the composition, and the second film-forming resin is present in the coating composition in an amount of 20 to 30 percent by weight, based on the total weight of resin solids in the composition.

13. The coating composition of claim 1, wherein the curing agent is selected from an aminoplast, a blocked polyisocyanate, or a mixture thereof.

14. The coating composition of claim 13, wherein the blocked polyisocyanate comprises a dimethyl blocked hexamethylene diisocyanate trimer.

15. The coating composition of claim 14, wherein the curing agent comprises a mixture of an aminoplast resin and a dimethylpyrazole blocked hexamethylene diisocyanate trimer, wherein the aminoplast resin and the dimethyl pyrazole blocked hexamethylene diisocyanate trimer are present in such a mixture at a weight ratio of 1:2 to 1:6.

16. The coating composition of claim 1, further comprising a property enhancing additive selected from (1) the reaction product of (i) a reactant comprising at least one isocyanate functional group with (ii) an active hydrogen containing alkoxypolyalkylene compound, (2) a reactive functional group-containing polysiloxane, or (3) a mixture thereof.

17. A substrate at least partially coated with the coating composition of claim 1.

18. A substrate at least partially coated with a multi-component composite coating comprising at least two coating layers, wherein at least one coating layer is deposited from the coating composition of claim 1.

19. An aqueous dispersion comprising an acrylic polyol which is the polymerization product of polymerizable materials comprising:
(i) a compound of the structure 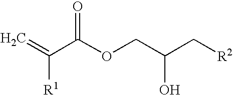
wherein R¹ is H or CH₃, and R² is 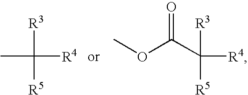
wherein R³ is H or an alkyl group, R⁴ is an alkyl group, and R⁵ is an alkyl group containing at least four carbon atoms,
(ii) a hydroxy-containing ethylenically unsaturated polymerizable material different from (i), and
(iii) an ethylenically unsaturated polymerizable material that is free of hydroxyl groups,
wherein the acrylic polyol is present in the aqueous dispersion in an amount of 30 to 40 percent by weight, based on the total weight of resin solids in the aqueous dispersion.

20. A method for improving the mar and/or chemical resistance of a coating deposited from a single component storage stable waterborne coating composition, the method comprising including in the coating composition an acrylic polyol which is the polymerization product of polymerizable materials comprising: (i) a compound of the structure 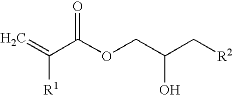
wherein R¹ is H or CH₃, and R² is 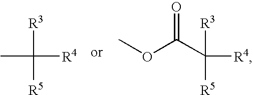
wherein R³ is H or an alkyl group, R⁴ is an alkyl group, and R⁵ is an alkyl group containing at least four carbon atoms; (ii) a hydroxy-containing ethylenically unsaturated polymerizable material; and (iii) an ethylenically unsaturated polymerizable material that is free of hydroxyl groups.
